(19) United States
(12) Patent Application Publication
(10) Pub. No.: US 2022/0292578 A1
(43) Pub. Date: Sep. 15, 2022

(54) ONE-TOUCH INTELLIGENT ONLINE SHOPPING ASSISTANT SYSTEM

(71) Applicant: International Business Machines Corporation, Armonk, NY (US)

(72) Inventors: Hamid Majdabadi, Ottawa (CA); Nadiya Kochura, Bolton, MA (US); Yang Liang, Beijing (CN); Su Liu, Austin, TX (US)

(21) Appl. No.: 17/198,326

(22) Filed: Mar. 11, 2021

(51) Int. Cl. G06Q 30/06; G06Q 30/02

(52) U.S. Cl. CPC G06Q 30/0635; G06Q 30/0204; G06Q 30/0641

(57) ABSTRACT

In an approach for placing an online order, a processor receives a request from a user through a user device to place an online order. A processor identifies a user profile for the user. A processor selects a shopping list from a set of shopping lists stored in the user profile based on shopping patterns and shopping history stored in the user profile. A processor customizes the selected shopping list based on the shopping patterns and shopping history stored in the user profile. A processor places the online order subsequent to receiving a confirmation by the user.

### BACKGROUND

The present disclosure relates generally to the field of artificial intelligence, and more particularly to a one-touch intelligent online shopping assistant system.

Artificial intelligence, sometimes also referred to as machine intelligence, may refer to a broad set of methods, algorithms, and technologies that enable systems, either in software or embodied forms, to display aspects of intelligent behavior in a way that may seem human-like to an outside observer. Machine learning may refer to a wide variety of algorithms and methodologies that enable systems to improve performance over time as the systems obtain more data and learn from the data. Online shopping may be a form of electronic commerce which allows consumers to directly buy goods or services from a seller over the Internet using a web browser or a mobile app. Consumers may find a product of interest by visiting the website of the retailer directly or by searching among alternative vendors using a shopping search engine, which displays the same product's availability and pricing at different e-retailers. Customers can shop online using a range of different computers and devices, including desktop computers, laptops, tablet computers and smartphones.

### SUMMARY

Aspects of an embodiment of the present disclosure disclose an approach for placing an online order. A processor receives a request from a user through a user device to place an online order. A processor identifies a user profile for the user. A processor selects a shopping list from a set of shopping lists stored in the user profile based on shopping patterns and shopping history stored in the user profile. A processor customizes the selected shopping list based on the shopping patterns and shopping history stored in the user profile. A processor places the online order subsequent to receiving a confirmation by the user.

### BRIEF DESCRIPTION OF THE DRAWINGS

FIG. 1 is a functional block diagram illustrating an intelligent online shopping assistant system, in accordance with an embodiment of the present disclosure.

FIG. 2 is a flowchart depicting operational steps of an intelligent online shopping module within the intelligent online shopping assistant system of FIG. 1, in accordance with an embodiment of the present disclosure.

FIG. 3 illustrates an exemplary functional diagram of the intelligent online module within the intelligent online shopping assistant system of FIG. 1, in accordance with an embodiment of the present disclosure.

FIG. 4 illustrates an exemplary functional flowchart of the intelligent online shopping module within the intelligent online shopping assistant system of FIG. 1, in accordance with an embodiment of the present disclosure.

FIG. 5 is a block diagram of components of an intelligent online shopping assistant (IOSA) server and an IOSA client of FIG. 1, in accordance with an embodiment of the present disclosure.

### DETAILED DESCRIPTION

The present disclosure is directed to systems and methods for users to place a one-click online order according to the shopping patterns of the users' previous online orders and interactions between the users and in-store shoppers based on artificial intelligent technologies. The in-store shoppers can be normal shoppers or volunteers who help the users shop.

Embodiments of the present disclosure disclose providing a one-touch intelligent online shopping assistant system for users (e.g., people with limited technology access). Embodiments of the present disclosure disclose defining a data structure for saving and tracking personalized grocery shopping requirements. Embodiments of the present disclosure disclose creating a user profile for defining and saving shopping preference and history. The shopping preference can be learned from the user's or others' off-line shopping activities and history. Embodiments of the present disclosure disclose sampling volunteer-user shopping data based on the volunteer-user shopping data in the client side. Embodiments of the present disclosure disclose learning shopping patterns. Embodiments of the present disclosure disclose categorizing a user into a proper user group. Embodiments of the present disclosure disclose classifying the order patterns (e.g., shopping lists based on user' characteristics). Embodiments of the present disclosure disclose receiving a user's call in an online shopping order center from a registered client device (e.g., a registered mobile phone). Embodiments of the present disclosure disclose identifying a user and understanding the user's request. Embodiments of the present disclosure disclose selecting a shopping list according to the user's shopping pattern (e.g., user group, shopping list). Embodiments of the present disclosure disclose customizing a selected shopping list. Embodiments of the present disclosure disclose placing the order according to the user's confirmation of, for example, the quantity of goods, price, payment method, and shipping address, or a predefined default agreement in a user profile.

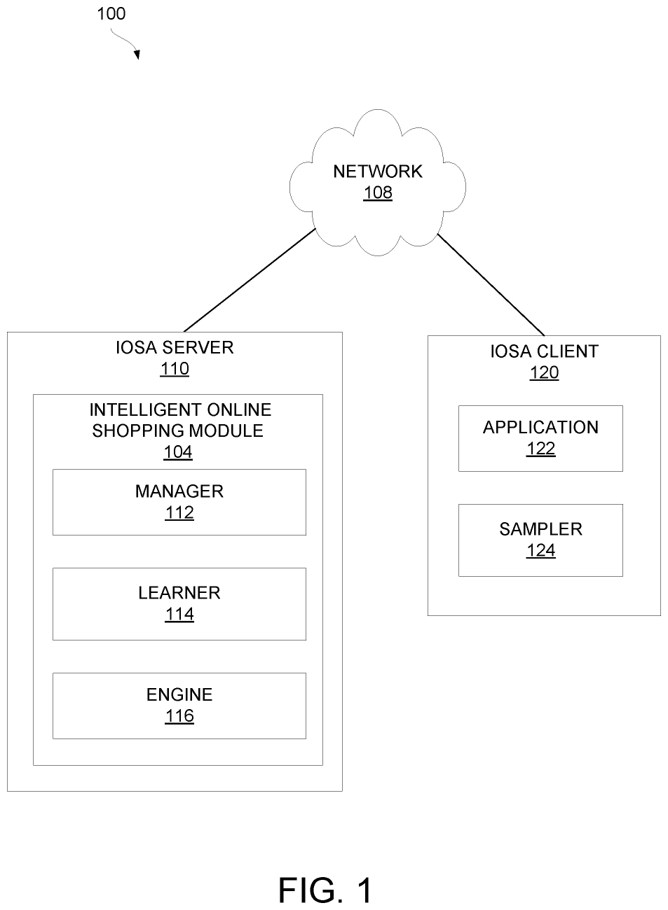

The present disclosure will now be described in detail with reference to the Figures. FIG. 1 is a functional block diagram illustrating an intelligent online shopping assistant system, generally designated 100, in accordance with an embodiment of the present disclosure.

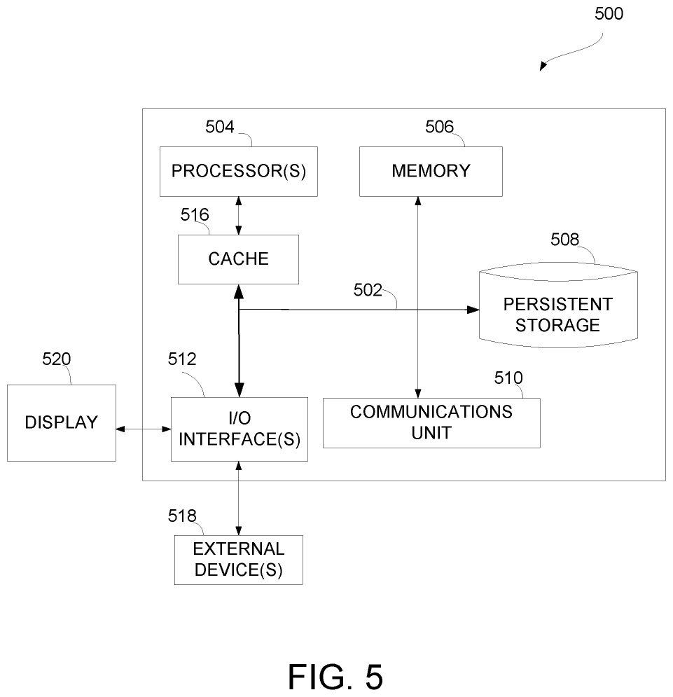

In the depicted embodiment, intelligent online shopping assistant system 100 includes IOSA server 110, IOSA client 120, and network 108. In various embodiments of the present disclosure, IOSA client 120 can be a laptop computer, a tablet computer, a netbook computer, a personal computer (PC), a desktop computer, a mobile phone, a smartphone, a smart watch, a wearable computing device, a personal digital assistant (PDA), or a server. In another embodiment, IOSA client 120 represents a computing system utilizing clustered computers and components to act as a single pool of seamless resources. In other embodiments, IOSA client 120 may represent a server computing system utilizing multiple computers as a server system, such as in a cloud computing environment. In general, IOSA client 120 can be any computing device or a combination of devices with access to application 122 and sampler 124 and network 108 and is capable of processing program instructions and executing application 122 and sampler 124, in accordance with an embodiment of the present disclosure. IOSA client 120 may include internal and external hardware components, as depicted and described in further detail with respect to FIG. 5.

Further, in the depicted embodiment, IOSA client 120 includes application 122 and sampler 124. In the depicted embodiment, application 122 and sampler 124 are located on IOSA client 120. However, in other embodiments, application 122 and sampler 124 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between IOSA client 120, application 122, and sampler 124, in accordance with a desired embodiment of the disclosure.

In the depicted embodiment, IOSA client 120 includes application 122 and sampler 124. In one or more embodiments, application 122 is to provide a one touch order for placing the order according to user's confirmation (e.g., amount, price, payment, shipping address). In one or more embodiments, sampler 124 is a module for sampling volunteer-user shopping data, for example, household characteristics (e.g., number of people in household, income), health conditions (e.g., diabetes, allergies), dietary restrictions (e.g., vegetarian, gluten-free, vegan, dairy-free), cost of living, shopping frequencies, and a shopping list. Sampler 124 may save the shopping data into a local log file. The user can disable this feature or must opt in to have their user information be obtained. The user is in control of what type of information is going to be collected and aware of how that information is going to be used.

In various embodiments of the present disclosure, IOSA server 110 may be a management server, a web server, or any other electronic device or computing system capable of processing program instructions and receiving and sending data. In some embodiments, IOSA server 110 may be a laptop computer, a tablet computer, a netbook computer, a personal computer (PC), a desktop computer, or any programmable electronic device. In other embodiments, IOSA server 110 may represent a server computing system utilizing multiple computers as a server system, such as in a cloud computing environment. In another embodiment, IOSA server 110 may represent a computing system utilizing clustered computers and components to act as a single pool of seamless resources. In general, IOSA server 110 can be any computing device or a combination of devices with access to intelligent online shopping module 104 and network 108 and is capable of processing program instructions and executing intelligent online shopping module 104, in accordance with an embodiment of the present disclosure. IOSA server 110 may include internal and external hardware components, as depicted and described in further detail with respect to FIG. 5.

Further, in the depicted embodiment, IOSA server 110 includes intelligent online shopping module 104. In the depicted embodiment, intelligent online shopping module 104 is located on IOSA server 110. However, in other embodiments, intelligent online shopping module 104 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between IOSA server 110 and intelligent online shopping module 104, in accordance with a desired embodiment of the disclosure.

In the depicted embodiment, intelligent online shopping module 104 includes manager 112, learner 114, and engine 116. In the depicted embodiment, manager 112, learner 114, and engine 116 are located on intelligent online shopping module 104 and IOSA server 110. However, in other embodiments, manager 112, learner 114, and engine 116 may be located externally and accessed through a communication network such as network 108.

In the depicted embodiment, intelligent online shopping module 104 includes manager 112, learner 114, and engine 116. In one or more embodiments, manager 112 is configured to define a framework of intelligent online shopping module 104 as a microservice. For example, as a software as a service, application 122 may call IOSA server 110 when a user sends a request to application 122. Manager 112 may include a data structure for saving and tracking personalized grocery shopping requirements. The data structure may include, for example, user identification, user device identification, user group identification, store identification, shopping event identification, shopping time, a shopping list, a payment method and other suitable data information. Manager 112 may include a service profile. The service file may be a configuration file for saving related configurations for intelligent online shopping module 104, for example, enabling or disabling the service, and needing a membership or not. Manager 112 may include one or more user groups. A list of user groups may be, for example, age based, health based, diet habits based, or other suitable groups. Manager 112 may include a default shopping list. The default shopping list may be associated with a user group. Manager 112 may include a user profile. The user profile may contain user's personal characteristics (e.g., age, health, diet habit, helper's info, payment sittings, and a shopping history). A shopping history may be a log file of shopping history (e.g., shopping dates, store names, shopped lists, costs). The user can disable this feature or must opt in to have their user information be obtained. The user is in control of what type of information is going to be collected and aware of how that information is going to be used.

In one or more embodiments, learner 114 is configured to learn user characteristics, user groups, and user shopping list patterns. Learner 114 may update a shopping list repository. The shopping list repository may be a database for storing a user-default shopping list. Learner 114 may include a user categorizer. The user categorizer may be a module for categorizing a user into a proper user group. Learner 114 may include a classifier. The classifier may be a module for classifying order patterns (e.g., shopping lists based on user' characteristics).

In one or more embodiments, engine 116 is configured to collaborate with IOSA client 120 to provide an intelligent online shopping assistant service. Engine 116 may receive a user's call in a service center from a registered client device, e.g., application 122 on a registered mobile device. Engine 116 may include a request analyzer. The request analyzer may be a module for identifying a user and understanding the user's request. Engine 116 may include an artificial intelligent (AI) shopping list selector. The AI shopping list selector may be a module for selecting a shopping list according to the user's shopping pattern (e.g., user group, shopping list). Engine 116 may include a customizer. The customizer may be a module for customizing the selected shopping list accordingly. For example, the customizer may customize the selected shopping list from the default shopping list based on additional information, e.g., “on sale” information. Engine 116 may include an order agent. The order agent may be a module for placing the order according to the user's confirmation (e.g., amount, price, payment, shipping address). In an example, engine 116 may be implemented utilizing a chatbot platform.

In one or more embodiments, intelligent online shopping module 104 is configured to receive a one-click request from a user through a user device to place an online order. The user may place the online order through application 122 from the user device. In an example, the user device may be a registered client device, e.g., a registered mobile phone. Application 122 may provide a one touch order for placing the order according to the user's confirmation (e.g., amount, price, payment, shipping address). Intelligent online shopping module 104 may sample volunteer-user shopping data, for example, household characteristics (e.g., family number, income), health condition (e.g., diabetes or not), diet habits (e.g., vegetarian or not), cost of living, shopping frequencies, and shopping list. Intelligent online shopping module 104 may save the shopping data into a local log file. Intelligent online shopping module 104 may identify the user and may understand the user's request.

In one or more embodiments, intelligent online shopping module 104 is configured to identify a user profile for the user. The user profile may contain the user's personal characteristics (e.g., age, health, diet habit, helper's information, payment sittings, and a shopping history). The user can disable this feature or must opt in to have their user information be obtained. The user is in control of what type of information is going to be collected and aware of how that information is going to be used. A shopping history may be a log file of shopping history (e.g., shopping dates, store names, shopped list, cost). The user profile may store user information, a set of shopping lists, shopping patterns, and shopping history of the user. The user information may include household characteristics, health condition, dietary requirements, cost of living, and shopping frequency. Intelligent online shopping module 104 may define a data structure for saving and tracking personalized shopping requirements. The data structure may define and include, for example, user identification, user device identification, user group identification, store identification, shopping event identification, shopping time, a shopping list, a payment method, and other suitable data information. Intelligent online shopping module 104 may create the user profile for defining and saving a shopping preference and history for the user.

In one or more embodiments, intelligent online shopping module 104 is configured to select a shopping list from the set of shopping lists stored in the user profile based on the shopping patterns and shopping history stored in the user profile. Intelligent online shopping module 104 may select the shopping list according to the user's shopping pattern (e.g., user group, shopping list). Intelligent online shopping module 104 may learn user characteristics, user groups, and user shopping list patterns. Intelligent online shopping module 104 may update a shopping list repository. The shopping list repository may be a database for storing a user-default shopping list. Intelligent online shopping module 104 may include a user categorizer. The user categorizer may be a module for categorizing a user into a proper user group. Intelligent online shopping module 104 may include a classifier. The classifier may be a module for classifying order patterns (e.g., shopping lists based on user' characteristics). Intelligent online shopping module 104 may sample volunteer-user shopping data, for example, household characteristics (e.g., family number, income), health condition (e.g., diabetes or not), diet habits (e.g., vegetarian or not), cost of living, shopping frequencies, and shopping list. Intelligent online shopping module 104 may categorize the user into a proper user group. Intelligent online shopping module 104 may classify order patterns (e.g., shopping lists based on user' characteristics).

In one or more embodiments, intelligent online shopping module 104 is configured to customize the selected shopping list based on the shopping patterns and shopping history stored in the user profile. Intelligent online shopping module 104 may learn the shopping patterns of the user based on previous online orders and interactions between the user and the in-store shopper. Intelligent online shopping module 104 may customize the selected shopping list accordingly based on the default shopping list (e.g., to replace orange with apple in the list because apple is on sale). Intelligent online shopping module 104 may include an AI shopping list selector. The AI shopping list selector may be a module for selecting a shopping list according to the user's shopping pattern (e.g., user group, shopping list). Intelligent online shopping module 104 may customize the selected shopping list accordingly. For example, intelligent online shopping module 104 may customize the selected shopping list from the default shopping list based on additional information, e.g., “on sale” information.

In one or more embodiments, intelligent online shopping module 104 is configured to place the order according to a confirmation by the user. The user may confirm and approve that the user accepts the price, payment method, and shipping address. Intelligent online shopping module 104 may place the order according to user's confirmation (e.g., amount, price, payment, shipping address). Intelligent online shopping module 104 may include an order agent. The order agent may be a module for placing the order according to the user's confirmation (e.g., amount, price, payment, shipping address). In an example, intelligent online shopping module 104 may be implemented utilizing a chatbot platform.

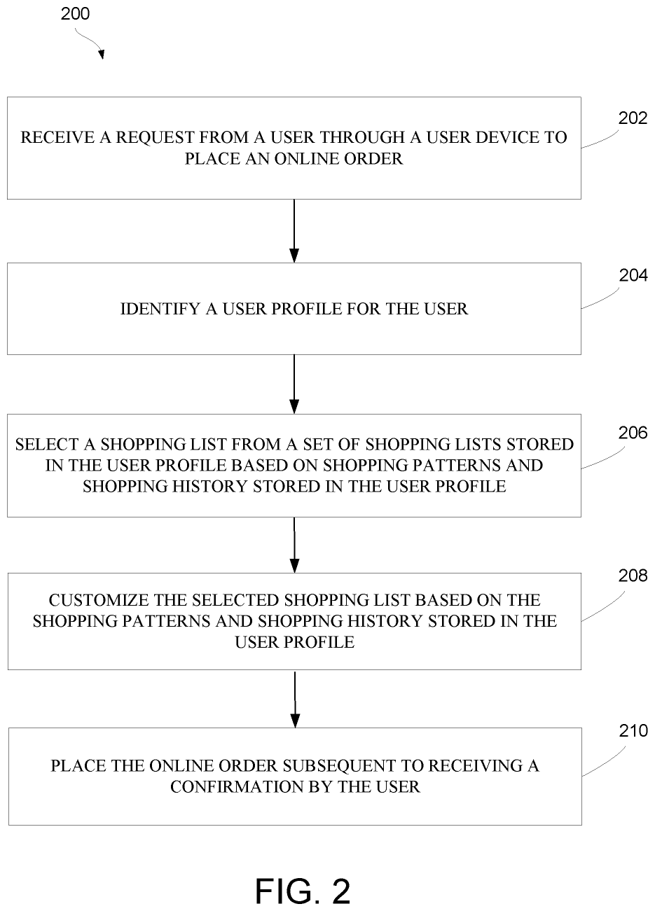

FIG. 2 is a flowchart 200 depicting operational steps of intelligent online shopping module 104 in accordance with an embodiment of the present disclosure.

Intelligent online shopping module 104 operates to receive a one-click request from a user through a user device to place an online order. Intelligent online shopping module 104 also operates to identify a user profile for the user. Intelligent online shopping module 104 operates to select a shopping list from the set of shopping lists stored in the user profile based on the shopping patterns and shopping history stored in the user profile. Intelligent online shopping module 104 operates to customize the selected shopping list based on the shopping patterns and shopping history stored in the user profile. Intelligent online shopping module 104 operates to place the order according to a confirmation by the user.

In step 202, intelligent online shopping module 104 receives a one-click request from a user through a user device to place an online order. The user may place the online order through application 122 from the user device. In an example, the user device may be a registered client device, e.g., a registered mobile phone. Application 122 may provide a one touch order for placing the order according to the user's confirmation (e.g., amount, price, payment, shipping address). Intelligent online shopping module 104 may sample volunteer-user shopping data, for example, household characteristics (e.g., family number, income), health condition (e.g., diabetes or not), diet habits (e.g., vegetarian or not), cost of living, shopping frequencies, and shopping list. Intelligent online shopping module 104 may save the shopping data into a local log file. Intelligent online shopping module 104 may identify the user and may understand the user's request.

In step 204, intelligent online shopping module 104 identifies a user profile for the user. The user profile may contain the user's personal characteristics (e.g., age, health, diet habit, helper's information, payment sittings, and a shopping history). The user can disable this feature or must opt in to have their user information be obtained. The user is in control of what type of information is going to be collected and aware of how that information is going to be used. A shopping history may be a log file of shopping history (e.g., shopping dates, store names, shopped list, cost). The user profile may store user information, a set of shopping lists, shopping patterns, and shopping history of the user. The user information may include household characteristics, health condition, diet requirements, cost of living, and shopping frequency. Intelligent online shopping module 104 may define a data structure for saving and tracking personalized shopping requirements. The data structure may define and include, for example, user identification, user device identification, user group identification, store identification, shopping event identification, shopping time, a shopping list, a payment method, and other suitable data information. Intelligent online shopping module 104 may create the user profile for defining and saving a shopping preference and history for the user.

In step 206, intelligent online shopping module 104 selects a shopping list from the set of shopping lists stored in the user profile based on the shopping patterns and shopping history stored in the user profile. Intelligent online shopping module 104 may select the shopping list according to the user's shopping pattern (e.g., user group, shopping list). Intelligent online shopping module 104 may learn user characteristics, user groups, and user shopping list patterns. Intelligent online shopping module 104 may update a shopping list repository. The shopping list repository may be a database for storing a user-default shopping list. Intelligent online shopping module 104 may include a user categorizer. The user categorizer may be a module for categorizing a user into a proper user group. Intelligent online shopping module 104 may include a classifier. The classifier may be a module for classifying order patterns (e.g., shopping lists based on user' characteristics). Intelligent online shopping module 104 may sample volunteer-user shopping data, for example, household characteristics (e.g., family number, income), health condition (e.g., diabetes or not), diet habits (e.g., vegetarian or not), cost of living, shopping frequencies, and shopping list. Intelligent online shopping module 104 may categorize the user into a proper user group. Intelligent online shopping module 104 may classify the order patterns (e.g., shopping lists based on user' characteristics).

In step 208, intelligent online shopping module 104 customizes the selected shopping list based on the shopping patterns and shopping history stored in the user profile. Intelligent online shopping module 104 may learn the shopping patterns of the user based on previous online orders and interactions between the user and the in-store shopper. Intelligent online shopping module 104 may customize the selected shopping list accordingly based on the default shopping list (e.g., to replace orange with apple in the list because apple is “on sale”). Intelligent online shopping module 104 may include an AI shopping list selector. The AI shopping list selector may be a module for selecting a shopping list according to the user's shopping pattern (e.g., user group, shopping list). Intelligent online shopping module 104 may customize the selected shopping list accordingly. For example, intelligent online shopping module 104 may customize the selected shopping list from the default shopping list based on additional information, e.g., “on sale” information.

In step 210, intelligent online shopping module 104 places the order after receiving a confirmation by the user. The user may confirm that the user accepts the items being purchased, the price, payment method, and shipping address. Intelligent online shopping module 104 may place the order according to user's confirmation (e.g., amount, price, payment, shipping address). Intelligent online shopping module 104 may include an order agent. The order agent may be a module for placing the order according to the user's confirmation (e.g., amount, price, payment, shipping address). In an example, intelligent online shopping module 104 may be implemented utilizing a chatbot platform.

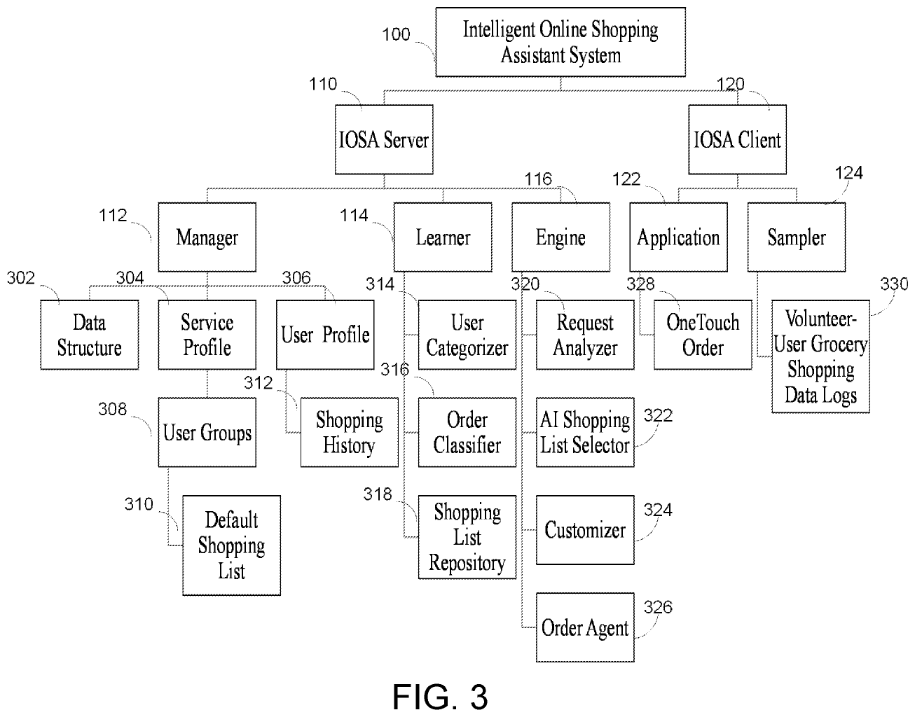

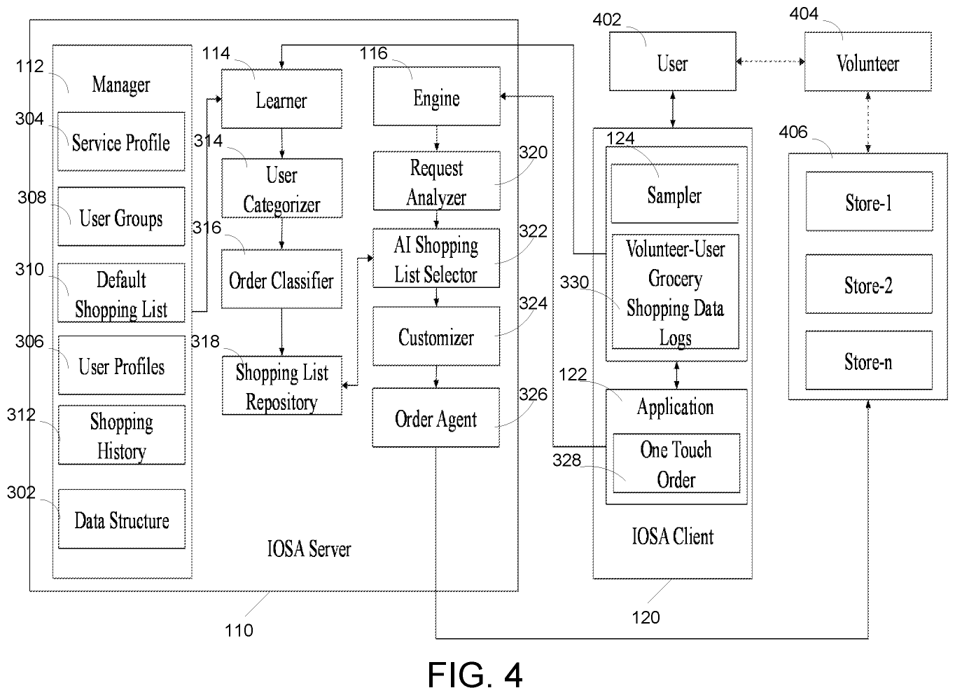

FIG. 3 illustrates an exemplary functional diagram of intelligent online shopping module 104 in accordance with an embodiment of the present disclosure. FIG. 4 illustrates an exemplary functional flowchart of intelligent online shopping module 104 in accordance with an embodiment of the present disclosure.

In the examples of FIG. 3 and FIG. 4, intelligent online shopping system 100 includes IOSA server 110 and IOSA client 120. IOSA server 110 includes intelligent online shopping module 104. Intelligent online shopping module 104 includes manager 112, learner 114, and engine 116. Manager 112 is configured to define a framework of intelligent online shopping module 104 as a microservice. For example, as a software as a service, application 122 may call IOSA server 110 when user 402 sends a request to application 122. Manager 112 includes data structure 302 for saving and tracking personalized grocery shopping requirements. Data structure 302 may include, for example, user identification, user device identification, user group identification, store identification, shopping event identification, shopping time, a shopping list, a payment method and other suitable data information. Manager 112 includes service profile 304. Service profile 304 may be a configuration file for saving related configurations for intelligent online shopping assistant 104, for example, enabling or disabling the service, and needing a membership or not. Manager 112 includes one or more user groups 308. A list of user groups 308 may be, for example, age based, health based, diet habits based, or other suitable groups. Manager 112 includes default shopping list 310. Default shopping list 310 may be associated with one or more user groups 308. Manager 112 includes user profile 306. User profile 306 may contain user's personal characteristics (e.g., age, health, diet habit, helper's info, payment sittings), and shopping history 312. Shopping history 312 may be a log file of shopping history (e.g., shopping dates, store names, shopped lists, costs). User 402 can disable this feature or must opt in to have their user information be obtained. User 402 is in control of what type of information is going to be collected and aware of how that information is going to be used.

Learner 114 is configured to learn user characteristics, user groups, and user shopping list patterns. Learner 114 may update shopping list repository 318. Shopping list repository 318 may be a database for storing a user-default shopping list. Learner 114 includes user categorizer 314. User categorizer 314 may be a module for categorizing user 402 into a proper user group. Learner 114 includes order classifier 316. Order classifier 316 may be a module for classifying order patterns (e.g., shopping lists based on user' characteristics).

Engine 116 is configured to collaborate with IOSA client 120 to provide an intelligent online shopping assistant service. Engine 116 may receive a user's call in a service center from a registered client device, e.g., application 122 on a registered mobile device. Engine 116 includes request analyzer 320. Request analyzer 320 may be a module for identifying user 402 and understanding the user's request. Engine 116 includes AI shopping list selector 322. AI shopping list selector 322 may be a module for selecting a shopping list according to the user's shopping pattern (e.g., user group, shopping list). Engine 116 includes customizer 324. Customizer 324 may be a module for customizing the selected shopping list accordingly. For example, customizer 324 may customize the selected shopping list from the default shopping list based on additional information, e.g., “on sale” information. Engine 116 includes order agent 326. Order agent 326 may be a module for placing the order according to the user's confirmation (e.g., amount, price, payment, shipping address). Order agent 326 may send the order information to store(s) 406. In an example, engine 116 may be implemented utilizing a chatbot platform.

IOSA client 120 includes application 122 and sampler 124. Application 122 may provide one touch order 328 for placing the order according to user's confirmation (e.g., amount, price, payment, shipping address). Sampler 124 may a module for sampling volunteer 404 -user 402 shopping data, for example, household characteristics (e.g., family number, income), health condition (e.g., diabetes or not), diet habits (e.g., vegetarian or not), cost of living, shopping frequencies, and shopping list. Sampler 124 may save the shopping data into a local log file. User 402 can disable this feature or must opt in to have their user information be obtained. User 402 is in control of what type of information is going to be collected and aware of how that information is going to be used.

FIG. 5 depicts a block diagram 500 of components of IOSA server 110 and IOSA client 120 in accordance with an illustrative embodiment of the present disclosure. It should be appreciated that FIG. 5 provides only an illustration of one implementation and does not imply any limitations with regard to the environments in which different embodiments may be implemented. Many modifications to the depicted environment may be made.

IOSA server 110 and IOSA client 120 may include communications fabric 502, which provides communications between cache 516, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of computer processor(s) 504 by holding recently accessed data, and data near accessed data, from memory 506.

Intelligent online shopping module 104 may be stored in persistent storage 508 and in memory 506 for execution by one or more of the respective computer processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Intelligent online shopping module 104 may be downloaded to persistent storage 508 through communications unit 510.

I/O interface(s) 512 allows for input and output of data with other devices that may be connected to IOSA server 110 and IOSA client 120. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., intelligent online shopping assistant 104 can be stored on such portable computer readable storage media and can be loaded onto persistent storage 508 via I/O interface(s) 512. I/O interface(s) 512 also connect to display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A computer-implemented method comprising:
receiving, by one or more processors, a request from a user through a user device to place an online order;
identifying, by the one or more processors, a user profile for the user;
selecting, by the one or more processors, a shopping list from a set of shopping lists stored in the user profile based on shopping patterns and shopping history stored in the user profile;
learning, by the one or more processors, the shopping patterns of the user based on the shopping history and interactions between the user and an off-line shopper who has helped the user to shop, wherein learning the shopping patterns of the user includes:
categorizing the user into a user group,
classifying the shopping patterns, and
updating a shopping list repository that stores a user-default shopping list;
customizing, by the one or more processors, the selected shopping list based on the shopping patterns and shopping history stored in the user profile; and
placing, by the one or more processors, the online order subsequent to receiving a confirmation by the user.

2. (canceled)

3. The computer-implemented method of claim 1, further comprising:
defining, by the one or more processors, a data structure for saving and tracking personalized shopping requirements, the data structure including user identification, identifier of the user device, identification of a user group, store identification, shopping event identification, shopping time, a shopping list, and a payment method.

4. The computer-implemented method of claim 1, further comprising:
creating, by the one or more processors, the user profile for defining and saving shopping preference and history, wherein the user profile stores user information, a set of shopping lists, shopping patterns, and shopping history of the user, wherein the user information includes household characteristics, health condition, diet requirements, financial information, and shopping frequency.

5. The computer-implemented method of claim 1, further comprising:
sampling, by the one or more processors, shopping data of the off-line shopper for the user; and
saving, by the one or more processors, the shopping data.

6-7. (canceled)

8. A computer program product comprising:
one or more computer readable storage media, and program instructions collectively stored on the one or more computer readable storage media, the program instructions comprising:
program instructions to receive a request from a user through a user device to place an online order;
program instructions to identify a user profile for the user;
program instructions to select a shopping list from a set of shopping lists stored in the user profile based on shopping patterns and shopping history stored in the user profile;
program instructions to learn the shopping patterns of the user based on the shopping history and interactions between the user and an off-line shopper who has helped the user to shop, wherein program instructions to learn the shopping patterns of the user include:
program instructions to categorize the user into a user group,
program instructions to classify the shopping patterns, and
program instructions to update a shopping list repository that stores a user-default shopping list;
program instructions to customize the selected shopping list based on the shopping patterns and shopping history stored in the user profile; and
program instructions to place the online order subsequent to receiving a confirmation by the user.

9. (canceled)

10. The computer program product of claim 8, further comprising:
program instructions, stored on the one or more computer-readable storage media, to define a data structure for saving and tracking personalized shopping requirements, the data structure including user identification, user device identification, identifier of the user device, identification of a user group, store identification, shopping event identification, shopping time, a shopping list, and a payment method.

11. The computer program product of claim 8, further comprising:
program instructions, stored on the one or more computer-readable storage media, to create the user profile for defining and saving shopping preference and history, wherein the user profile stores user information, a set of shopping lists, shopping patterns, and shopping history of the user, wherein the user information includes household characteristics, health condition, diet requirements, financial information, and shopping frequency.

12. The computer program product of claim 8, further comprising:
program instructions, stored on the one or more computer-readable storage media, to sample shopping data of the off-line shopper for the user; and
program instructions, stored on the one or more computer-readable storage media, to save the shopping data.

13-14. (canceled)

15. A computer system comprising:
one or more computer processors, one or more computer readable storage media, and program instructions stored on the one or more computer readable storage media for execution by at least one of the one or more computer processors, the program instructions comprising:
program instructions to receive a request from a user through a user device to place an online order;
program instructions to identify a user profile for the user;
program instructions to select a shopping list from a set of shopping lists stored in the user profile based on shopping patterns and shopping history stored in the user profile;
program instructions to customize the selected shopping list based on the shopping patterns and shopping history stored in the user profile; and
program instructions to place the online order subsequent to receiving a confirmation by the user.

16. (canceled)

17. The computer system of claim 15, further comprising:
program instructions, stored on the one or more computer-readable storage media, to define a data structure for saving and tracking personalized shopping requirements, the data structure including user identification, user device identification, identifier of the user device, identification of a user group, store identification, shopping event identification, shopping time, a shopping list, and a payment method.

18. The computer system of claim 15, further comprising:
program instructions, stored on the one or more computer-readable storage media, to create the user profile for defining and saving shopping preference and history, wherein the user profile stores user information, a set of shopping lists, shopping patterns, and shopping history of the user, wherein the user information includes household characteristics, health condition, diet requirements, financial information, and shopping frequency.

19. The computer system of claim 15, further comprising:
program instructions, stored on the one or more computer-readable storage media, to sample shopping data of the off-line shopper for the user; and
program instructions, stored on the one or more computer-readable storage media, to save the shopping data.

20. (canceled)
